(19) United States
(12) Patent Application Publication
(10) Pub. No.: US 2026/0135707 A1
(43) Pub. Date: May 14, 2026

(54) SYSTEMS AND METHODS FOR AUTHENTICATION BASED ON IMAGE OR VIDEO OF SECRET CREDENTIALS

(71) Applicant: JPMORGAN CHASE BANK, N.A., New York, NY (US)

(72) Inventors: Goran LONCARIC, Frisco, TX (US); Gilda RAZI, Norwood, NJ (US); Gerardo GEAN, Plano, TX (US)

(21) Appl. No.: 19/383,071

(22) Filed: Nov. 7, 2025

Related U.S. Application Data
(60) Provisional application No. 63/720,045, filed on Nov. 13, 2024.

(51) Int. Cl. H04L 9/32; H04L 9/00

(52) U.S. Cl. CPC H04L 9/32; H04L 9/008

(57) ABSTRACT

A method may include: a backend computer program receiving a first login from a mobile computer application and prompting the mobile computer application to capture an image or a video of a secret credential; the mobile computer application capturing the image or the video of the secret credential and converting the image or video of the secret credential into a first representation; the backend computer program receiving the first representation from the mobile computer application; the mobile computer application receiving a second login and an image or video of a received secret credential and converting the image or video of the received secret credential into a second representation; the backend computer program comparing the first representation to the second representation and controlling the mobile computer application to take an action in response to the first representation matching the second representation within a degree of confidence.

### RELATED APPLICATIONS

This application claims the benefit of, and priority to, U.S. Provisional Patent Application Ser. No. 63/720,045, filed Nov. 13, 2024, the disclosure of which is hereby incorporated, by reference, in its entirety.

### BACKGROUND OF THE INVENTION

### 1. Field of the Invention

Embodiments relate to systems and methods for authentication based on image or video of secret credentials.

### 2. Description of the Related Art

The movement towards online and mobile banking and shopping creates a wider attack surface for fraudsters. Criminals are constantly developing new tricks to mimic banks and clients. Fraudsters steal login credentials to gain access to bank accounts to transfer funds, and even intercept or trick customers to reveal out-of-band communications in order gain such access.

### SUMMARY OF THE INVENTION

Systems and methods for authentication based on image or video of secret credentials are disclosed. According to an embodiment, a method may include: receiving, by a backend computer program executed by a backend electronic device, a first login for a user from a mobile computer application executed by a mobile electronic device; prompting, by the backend computer program, the mobile computer application to capture an image or a video of a secret credential; capturing, by the mobile computer application and using a camera on the mobile electronic device, the image or the video of the secret credential; converting, by the mobile computer application, the image or video of the secret credential into a first representation; receiving, by the backend computer program, the first representation from the mobile computer application; receiving, by the mobile computer application, a second login and an image or video of a received secret credential for the user; converting, by the mobile computer application, the image or video of the received secret credential into a second representation; comparing, by the backend computer program, the first representation to the second representation; and controlling, by the backend computer program, the mobile computer application to take an action in response to the first representation matching the second representation within a degree of confidence.

In one embodiment, the secret credential or the received secret credential may include an object or a gesture.

In one embodiment, the step of converting the image or video of the secret credential into the first representation may include prompting, by the mobile computer application, a large language model or a video language model to provide a summary of the image or video of the secret credential, wherein the first representation may include the summary received from the large language model or the video language model; and the step of converting the image or video of the received secret credential into a second representation may include prompting, by the mobile computer application, the large language model or the video language model to provide a summary of the image or video of the received secret credential, wherein the second representation may include the summary received from the large language model or the video language model.

In one embodiment, the first representation compromises a mathematical representation of the image or video of the secret credential, and the second representation compromises a mathematical representation of the image or video of the received secret credential.

In one embodiment, the method may also include encrypting, by the mobile computer application, the first representation before communicating the first representation to the backend computer program; and encrypting, by the mobile computer application, the second representation before communicating the second representation to the backend computer program.

In one embodiment, the first representation and the second representation are encrypted using fully homomorphic encryption.

In one embodiment, the method may also include determining, by the backend computer program, that the mobile electronic device is eligible for secret credential login based on technical features of the mobile electronic device; and determining, by the backend computer program, that the user passes a risk assessment based on a user profile, a user tenure, and a presence of high-risk transactions from the user.

According to another embodiment, a system may include: a mobile electronic device executing a mobile computer application; and a backend electronic device executing a backend computer program. The backend computer program may be configured to receive a first login for a user from the mobile computer application; the backend computer program may be configured to prompt the mobile computer application to capture an image or a video of a secret credential; the mobile computer application may be configured to capture, using a camera on the mobile electronic device, the image or the video of the secret credential; the mobile computer application may be configured to convert the image or video of the secret credential into a first representation; the backend computer program may be configured to receive the first representation from the mobile computer application; the mobile computer application may be configured to receive second login and an image or video of a received secret credential for the user; the mobile computer application may be configured to convert the image or video of the received secret credential into a second representation; the backend computer program may be configured to compare the first representation to the second representation; and the backend computer program may be configured to control the mobile computer application to take an action in response to the first representation matching the second representation within a degree of confidence.

In one embodiment, the secret credential or the received secret credential may include an object.

In one embodiment, the secret credential or the received secret credential may include a gesture.

In one embodiment, the mobile computer application may be configured to convert the image or video of the secret credential into the first representation by prompting a large language model or a video language model to provide a summary of the image or video of the secret credential, wherein the first representation may include the summary received from the large language model or the video language model; and the mobile computer application may be configured to convert the image or video of the received secret credential into a second representation by prompting the large language model or the video language model to provide a summary of the image or video of the received secret credential, wherein the second representation may include the summary received from the large language model or the video language model.

In one embodiment, the first representation compromises a mathematical representation of the image or video of the secret credential, and the second representation compromises a mathematical representation of the image or video of the received secret credential.

In one embodiment, the mobile computer application may be configured to encrypt the first representation before communicating the first representation to the backend computer program; and the mobile computer application may be configured to encrypt the second representation before communicating the second representation to the backend computer program.

In one embodiment, the first representation and the second representation are encrypted using fully homomorphic encryption.

In one embodiment, the backend computer program may be configured to determine that the mobile electronic device is eligible for secret credential login based on technical features of the mobile electronic device; and the backend computer program may be configured to determine that the user passes a risk assessment based on a user profile, a user tenure, and a presence of high-risk transactions from the user.

According to another embodiment, a non-transitory computer readable storage medium may include instructions stored thereon, which when read and executed by one or more computer processors, cause the one or more computer processors to perform steps comprising: receiving, from a mobile computer application executed by a mobile electronic device, a first login for a user; prompting the mobile computer application to capture an image or a video of a secret credential; receiving, from the mobile computer application, a first representation of an image or the video of the secret credential captured by a camera on the mobile electronic device; receiving, from the mobile computer application, a second login; receiving, from the mobile computer application, a second representation of a received secret credential captured by the camera on the mobile electronic device; comparing the first representation to the second representation; and controlling the mobile computer application to take an action in response to the first representation matching the second representation within a degree of confidence.

In one embodiment, the first representation may include a mathematical representation or a summary of the image or video of the secret credential, and the second representation may include a mathematical representation or a summary of the image or video of the received secret credential.

In one embodiment, the first representation and the second representation are encrypted using fully homomorphic encryption.

In one embodiment, the non-transitory computer readable storage medium may also include instructions stored thereon, which when read and executed by the one or more computer processors, cause the one or more computer processors to perform steps comprising: determining that the mobile electronic device is eligible for secret credential login based on technical features of the mobile electronic device; and determining that the user passes a risk assessment based on a user profile, a user tenure, and a presence of high-risk transactions from the user.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for authentication based on image or video of secret credentials according to an embodiment;

FIG. 2 illustrates a method for registration of image or video of secret credentials according to an embodiment;

FIG. 3 illustrates a method for authentication based on image or video of secret credentials according to an embodiment;

FIG. 4 depicts an exemplary computing system for implementing aspects of the present disclosure.

### DETAILED DESCRIPTION OF PREFERRED EMBODIMENTS

This disclosure generally relates to systems and methods for authentication based on image or video of secret credentials.

In one embodiment, a user may create an image or video of a secret credential, such as an image of an object that is in the user’s possession, or a gesture made by the user, and use that secret credential to authenticate the user during login. During enrollment, using a mobile computer program, the user may be prompted to take an image or video of a secret credential, such as an object (e.g., a pen, a key fob, a watch, jewelry, etc.), a gesture (e.g., raising a number of fingers, waving, etc.), etc. and may set that as the user’s secret credential. The image or video may then be encrypted and stored at a backend.

When asked to verify themselves at a later time, the user may be prompted by the mobile computer program to capture an image or video of the secret credential. The mobile computer program may then take a picture or video of the secret credential, of the gesture, and may send it to a backend computer program for authentication. The backend computer program may compare the current image or video to the stored image or video; if they match within a degree of certainty, the user may be allowed to proceed. If the images or videos do not match, access may be blocked, and the user may have to authenticate in a different way.

Embodiments may facilitate authentication with less friction by having users use their camera to capture or record an object of their choice that they will have with them upon subsequent logins (e.g., a pen), or make a gesture, and use that during login.

Embodiments provide phishing protection, enhanced user authentication (i.e., two factor authentication) using something the user has, provide increased user confidence and trust, and may provide behavioral analysis for unusual patterns or gestures.

Unlike using biometrics, the secret credential may be known only to the user, therefore increasing security as a fraudster will not know the user’s secret credential. Without knowing the secret credential, a fraudster is less likely to be able to spoof the system.

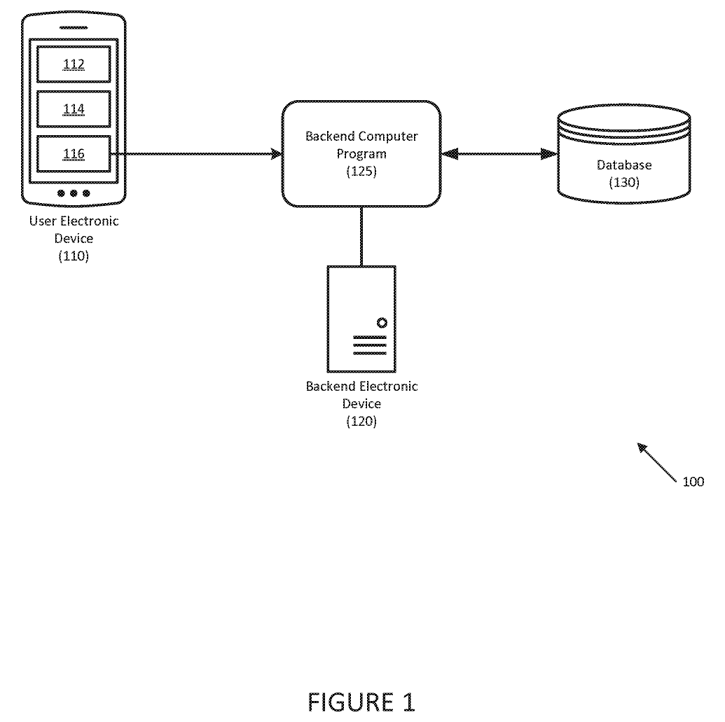

Referring to FIG. 1, a system for authentication based on image or video of secret credentials is provided according to an embodiment. System 100 may include user electronic device 110, which may be a mobile electronic device, such as a smartphone, a computer (e.g., a notebook, a laptop, a tablet, etc.), a headset (e.g., augmented reality headsets, virtual reality headsets, smart glasses, etc.), etc. User electronic device 110 may include camera 112, memory 114, and may execute mobile computer program 116.

Mobile computer program 116 may communicate with backend computer program 125 that may be executed by backend electronic device 120 (e.g., a physical and/or cloud-based server). In one embodiment, mobile computer program 116 may be an application that accesses backend computer program 125, or it may be a browser that accesses backend computer program 125.

Backend computer program 125 may interface with database 130 that may store, for example, user credentials, such as images or videos. The user credentials may be images or videos or objects, gestures, etc. that were captured by camera 112.

In one embodiment, the credentials may also be stored in memory 114 of user electronic device 110. For example, memory 114 may be secure memory (e.g., a secure element) of user electronic device 110.

Backend computer program 125 may compare an image or video of a received secret credential from mobile computer program 116 and may to a stored image or video of the secret credential in database 130 for a user. If the comparison passes, backend computer program 125 may control mobile computer program 116 to proceed to a landing page, a dashboard, or to execute a desired action. For example, backend computer program 125 may control a door to open, a lock to unlock, etc. to provide access to an area, may enable a vehicle to start, may be used by the operating system (not shown) of user electronic device 110 to unlock user electronic device 110 for a user, etc.

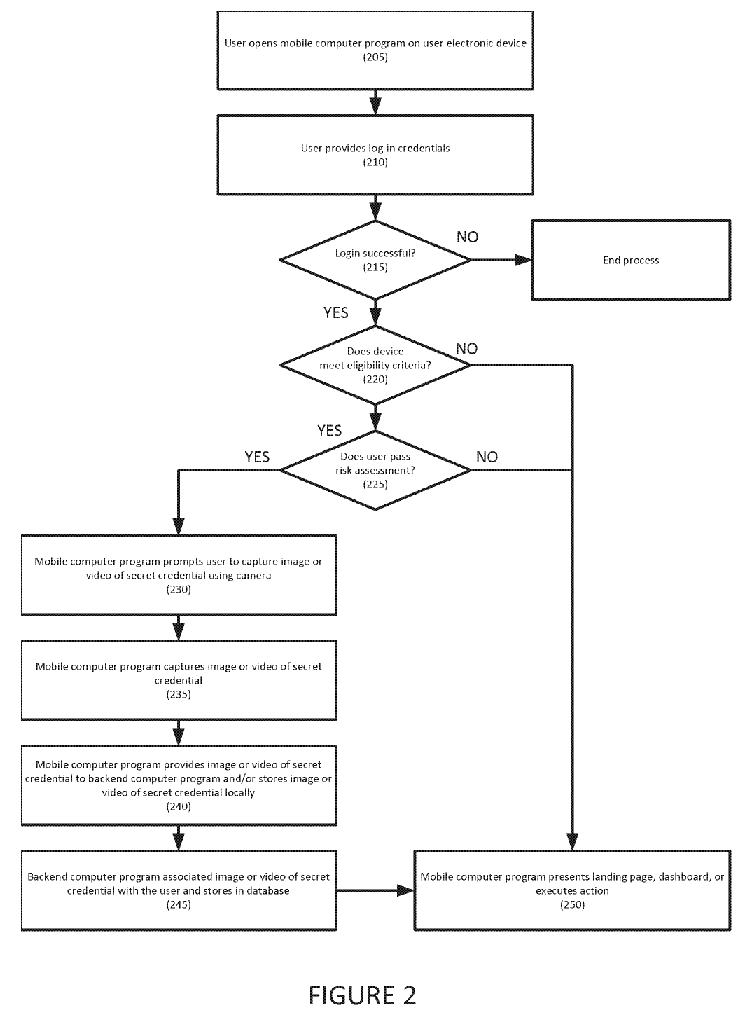

Referring to FIG. 2, a method for registration of image or video of secret credentials is provided according to an embodiment.

In step 205, a user, such as a customer, may open a mobile application executed by the user’s mobile electronic device. The mobile electronic device may be a smart phone, a tablet computer, a virtual reality/augmented reality device, etc. The mobile application may be associated with a trusted entity, such as a financial institution.

In step 210, the mobile application may receive the user’s login credentials, such as a username and password, a biometric, etc.

In step 215, the backend computer program may receive the login credentials from the mobile computer program and may determine if the login is successful. If it is, in step 220, the backend computer program may determine whether the user electronic device meets eligibility criteria for authentication using image or video of a secret credential.

In one embodiment, the eligibility criteria may be based on the technical features of the user’s mobile electronic device, such as the availability of the user’s mobile electronic device and camera, the ability of the camera to capture images, video, and/or sound, etc. The eligibility criteria may also be based on the security of the user’s mobile electronic device, such as the length of time that it has been registered (i.e., recently registered devices may be risky), a geolocation of the user electronic device, whether the user’s mobile electronic device has been jailbroken, etc.

If the user electronic device is eligible, in step 225, the backend computer program may determine if the user passes a risk assessment. For example, the backend computer program may assess the risk for the user, based on the user profile, the length of time that the user has been registered, whether there have been any high-risk transactions, etc.

In one embodiment, risk rules may be applied to determine if additional authentication is required.

In one embodiment, the eligibility check and the risk assessment may be conducted in any order, simultaneously, etc. The levels required for eligibility and risk may be dynamic.

If the user passes the risk assessment, in step 230, the mobile computer program may prompt the user to capture an image or video of a secret credential. The secret credential may be an object, a gesture, etc.

In one embodiment, the mobile computer program may verify that the image or the video of the secret credential is complicated enough to provide a required degree of security. For example, mobile computer program may verify that secret credential is clear enough to be distinguished from background noise, has distinctive characteristics that differentiate it from other items, etc.

In step 235, the mobile computer program may capture an image or video of the secret credential, and, in step 240, may provide the image or video of the secret credential to the backend computer program. Alternatively, or in addition, the mobile computer program may store the image or video of the secret credential locally in, for example, secure storage. The image or video may be encrypted before it is stored.

In one embodiment, when the image or video is captured, the mobile application may convert the image or video into a representation of the image or video. For example, the image or video may be converted into a mathematical representation, such as one or more vector or tokens.

In another embodiment, the image or video may be provided to a Large Language Model (LLM) or a Video Language Model (VLM) with a prompt to describe the contents of the image or video, etc. The description output by the LLM or VLM may be used as the representation of the video or image.

In step 245, the backend computer program may associate the image or video of secret credential, or the representation thereof, with the user, and may store it in a database. The image or video, or the representation, may be encrypted before it is stored.

In one embodiment, the mobile application and/or the server may employ full homomorphic encryption (FHE) to encrypt the image or video or the representation. This allows the secret image/gesture to be compared to a received picture if it is also encrypted using FHE.

In step 250, the mobile computer program may present a landing page, a dashboard, or may execute an action in response to the successful login.

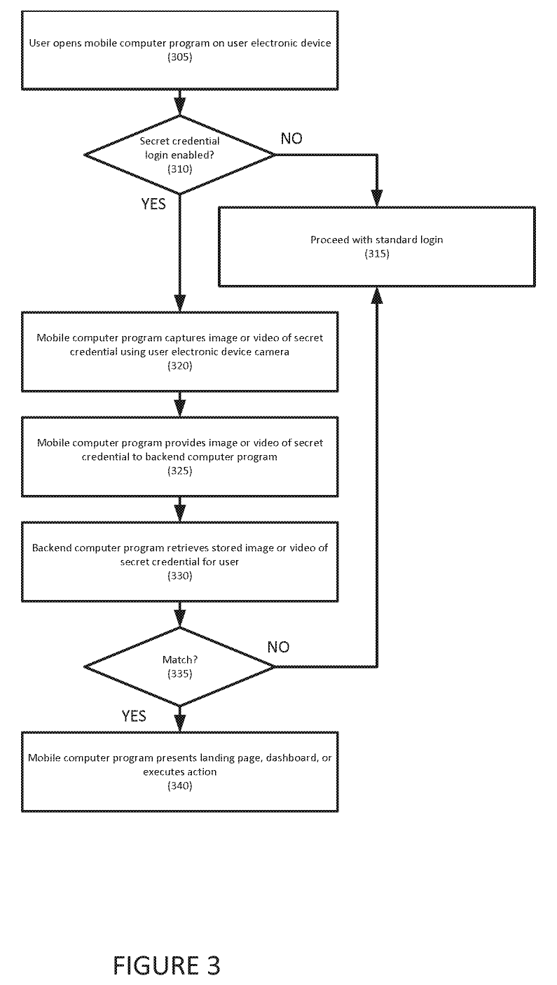

Referring to FIG. 3, a method for authentication based on image or video of secret credentials is disclosed according to an embodiment.

In step 305, the user may open a mobile computer program on a user electronic device.

In step 310, the mobile computer program may determine whether secret credential login is enabled. If it is not, in step 315, the mobile computer program may proceed with standard login (e.g., steps 210 and 215).

In one embodiment, an indicator may be stored on the user electronic device that indicates whether secret credential login is enabled.

If secret credential login is enabled, in step 320, the mobile computer program may prompt the user to present the secret credential to the camera, and the camera may capture an image or video of the secret credential.

In step 325, the mobile computer program may provide the image or video of secret credential to the backend computer program.

In one embodiment, when the image or video is captured, the mobile application may convert the image or video into a representation of the image or video. For example, the image or video may be converted into a mathematical representation, such as one or more vector or tokens, or it may be provided to a LLM or a VLM with a prompt to describe the contents of the image or video, etc. The description output by the LLM or VLM may be used as the representation of the received video or image.

In one embodiment, the mobile application may encrypt the image or video, or the representation thereof, before it is sent to the backend. The mobile application and/or server may encrypt the image or video or the representation using the same method used during registration.

In step 330, the backend computer program may retrieve the stored image or video of secret credential for the user, or the representation/summary of the image or video.

In step 335, the backend computer program may determine whether the secret credential in the received image or video matches the stored secret credential in the stored image or video within a degree of confidence. In one embodiment, the backend computer program may decrypt the stored credential, and may compare the received secret credential to the received picture or video. In another embodiment, if FHE is used, the backend computer program may encrypt the image or video received and may compare it to the retrieved encrypted image or video without decryption.

In another embodiment, the backend computer program may compare the mathematical representation or description of the stored image or video to the stored mathematical representation or description.

Any suitable method for comparing the received secret credential to the stored secret credential, or for comparing the mathematical representation/summary of the received secret credential to the stored mathematical representation/summary.

If the received secret credential or mathematical representation/summary thereof matches the stored secret credential or mathematical representation/summary within a degree of confidence, in step 340, the backend computer program may control the mobile computer program to present a landing page, a dashboard, or to execute an action. For example, the backend computer program may send a control signal to the mobile computer program causing the mobile computer program to present a landing page, a dashboard, or to execute an action. The backend computer program may also send a control signal to the mobile electronic devices that causes the mobile electronic device to take an action such as unlocking the mobile electronic device, etc.

In one embodiment, the backend computer program may send a control signal a separate device (e.g., a lock, a door, etc.) to unlock and to grant access to an area.

In one embodiment, the required degree of confidence may be based on a risk associated with the transaction.

If the images or videos do not match, the stored image or video within a degree of confidence, in step 315, the backend computer program may instruct the mobile computer program to present the standard login page, or may deny access.

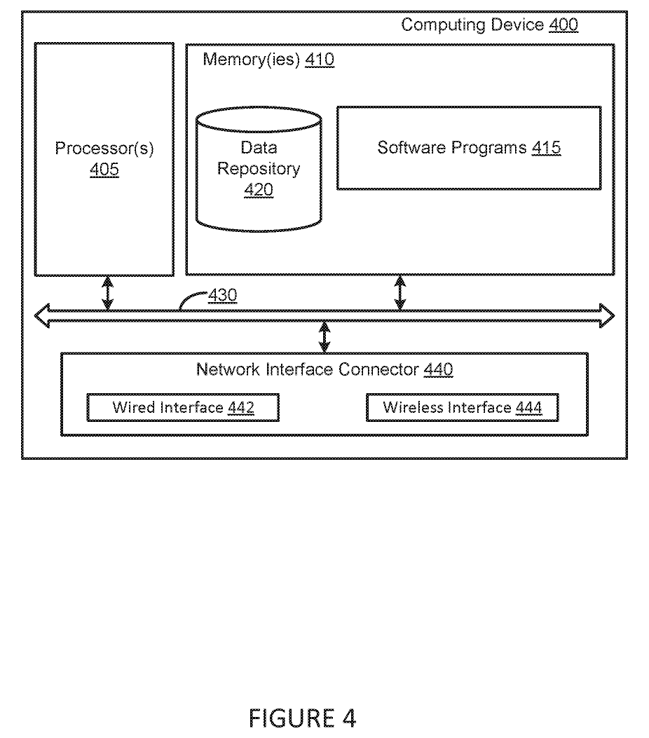

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a backend computer program executed by a backend electronic device, a first login for a user from a mobile computer application executed by a mobile electronic device;
prompting, by the backend computer program, the mobile computer application to capture an image or a video of a secret credential;
capturing, by the mobile computer application and using a camera on the mobile electronic device, the image or the video of the secret credential;
converting, by the mobile computer application, the image or video of the secret credential into a first representation;
receiving, by the backend computer program, the first representation from the mobile computer application;
receiving, by the mobile computer application, a second login and an image or video of a received secret credential for the user;
converting, by the mobile computer application, the image or video of the received secret credential into a second representation;
comparing, by the backend computer program, the first representation to the second representation; and
controlling, by the backend computer program, the mobile computer application to take an action in response to the first representation matching the second representation within a degree of confidence.

2. The method of claim 1, wherein the secret credential or the received secret credential comprises an object.

3. The method of claim 1, wherein the secret credential or the received secret credential comprises a gesture.

4. The method of claim 1, wherein the step of converting the image or video of the secret credential into the first representation comprises prompting, by the mobile computer application, a large language model or a video language model to provide a summary of the image or video of the secret credential, wherein the first representation comprises the summary received from the large language model or the video language model; and
the step of converting the image or video of the received secret credential into a second representation comprises prompting, by the mobile computer application, the large language model or the video language model to provide a summary of the image or video of the received secret credential, wherein the second representation comprises the summary received from the large language model or the video language model.

5. The method of claim 1, wherein the first representation compromises a mathematical representation of the image or video of the secret credential, and the second representation compromises a mathematical representation of the image or video of the received secret credential.

6. The method of claim 1, further comprising:
encrypting, by the mobile computer application, the first representation before communicating the first representation to the backend computer program; and
encrypting, by the mobile computer application, the second representation before communicating the second representation to the backend computer program.

7. The method of claim 6, wherein the first representation and the second representation are encrypted using fully homomorphic encryption.

8. The method of claim 1, further comprising:
determining, by the backend computer program, that the mobile electronic device is eligible for secret credential login based on technical features of the mobile electronic device; and
determining, by the backend computer program, that the user passes a risk assessment based on a user profile, a user tenure, and a presence of high-risk transactions from the user.

9. A system, comprising:
a mobile electronic device executing a mobile computer application; and
a backend electronic device executing a backend computer program;
wherein:
the backend computer program is configured to receive a first login for a user from the mobile computer application;
the backend computer program is configured to prompt the mobile computer application to capture an image or a video of a secret credential;
the mobile computer application is configured to capture, using a camera on the mobile electronic device, the image or the video of the secret credential;
the mobile computer application is configured to convert the image or video of the secret credential into a first representation;
the backend computer program is configured to receive the first representation from the mobile computer application;
the mobile computer application is configured to receive second login and an image or video of a received secret credential for the user;
the mobile computer application is configured to convert the image or video of the received secret credential into a second representation;
the backend computer program is configured to compare the first representation to the second representation; and
the backend computer program is configured to control the mobile computer application to take an action in response to the first representation matching the second representation within a degree of confidence.

10. The system of claim 9, wherein the secret credential or the received secret credential comprises an object.

11. The system of claim 9, wherein the secret credential or the received secret credential comprises a gesture.

12. The system of claim 9, wherein the mobile computer application is configured to convert the image or video of the secret credential into the first representation by prompting a large language model or a video language model to provide a summary of the image or video of the secret credential, wherein the first representation comprises the summary received from the large language model or the video language model; and
the mobile computer application is configured to convert the image or video of the received secret credential into a second representation by prompting the large language model or the video language model to provide a summary of the image or video of the received secret credential, wherein the second representation comprises the summary received from the large language model or the video language model.

13. The system of claim 9, wherein the first representation compromises a mathematical representation of the image or video of the secret credential, and the second representation compromises a mathematical representation of the image or video of the received secret credential.

14. The system of claim 9, wherein:
the mobile computer application is configured to encrypt the first representation before communicating the first representation to the backend computer program; and
the mobile computer application is configured to encrypt the second representation before communicating the second representation to the backend computer program.

15. The system of claim 14, wherein the first representation and the second representation are encrypted using fully homomorphic encryption.

16. The system of claim 10, wherein:
the backend computer program is configured to determine that the mobile electronic device is eligible for secret credential login based on technical features of the mobile electronic device; and
the backend computer program is configured to determine that the user passes a risk assessment based on a user profile, a user tenure, and a presence of high-risk transactions from the user.

17. A non-transitory computer readable storage medium, including instructions stored thereon, which when read and executed by one or more computer processors, cause the one or more computer processors to perform steps comprising:
receiving, from a mobile computer application executed by a mobile electronic device, a first login for a user;
prompting the mobile computer application to capture an image or a video of a secret credential;
receiving, from the mobile computer application, a first representation of an image or the video of the secret credential captured by a camera on the mobile electronic device;
receiving, from the mobile computer application, a second login;
receiving, from the mobile computer application, a second representation of a received secret credential captured by the camera on the mobile electronic device;
comparing the first representation to the second representation; and
controlling the mobile computer application to take an action in response to the first representation matching the second representation within a degree of confidence.

18. The non-transitory computer readable storage medium of claim 17, wherein the first representation comprises a mathematical representation or a summary of the image or video of the secret credential, and the second representation comprises a mathematical representation or a summary of the image or video of the received secret credential.

19. The non-transitory computer readable storage medium of claim 17, wherein the first representation and the second representation are encrypted using fully homomorphic encryption.

20. The non-transitory computer readable storage medium of claim 17, further including instructions stored thereon, which when read and executed by the one or more computer processors, cause the one or more computer processors to perform steps comprising:
determining that the mobile electronic device is eligible for secret credential login based on technical features of the mobile electronic device; and
determining that the user passes a risk assessment based on a user profile, a user tenure, and a presence of high-risk transactions from the user.
